(19) United States
(12) Patent Application Publication
(10) Pub. No.: US 2022/0284599 A1
(43) Pub. Date: Sep. 8, 2022

(54) POSITION ESTIMATING METHOD, POSITION ESTIMATING SYSTEM, AND POSITION ESTIMATING APPARATUS

(71) Applicant: NEC Corporation, Minato-ku, Tokyo (JP)

(72) Inventor: Shinya YASUDA, Tokyo (JP)

(73) Assignee: NEC Corporation, Minato-ku, Tokyo (JP)

(21) Appl. No.: 17/637,172

(22) PCT Filed: Sep. 4, 2019
(86) PCT No.: PCT/JP2019/034807

§ 371 Date: Feb. 22, 2022

(51) Int. Cl. G06T 7/285; G06T 7/70; G06T 3/40; H04N 13/25

(52) U.S. Cl. CPC G06T 7/285; G06T 7/70; G06T 3/40; H04N 13/25; G06T 2207/20068; G06T 2207/10012; G06T 2207/10028; H04N 2013/0085

(57) ABSTRACT

In order to appropriately estimated a position of a moving object on the basis of a captured image, a position estimating apparatus 100 includes an obtaining section 110 configured to obtain an image coordinates representing an image position of a moving object 300 in an image captured by an imaging apparatus 200, and a converting section 130 configured to convert the image coordinates for the moving object 300 to real space coordinates for the moving object 300, based on information obtained from a correspondence between real space coordinate information indicating a predetermined point in a real space and image coordinate information representing the predetermined point.

### BACKGROUND

### Technical Field

The present invention relates to a position estimating method, a position estimating system, and a position estimating apparatus for estimating real space coordinates in a three-dimensional space from a captured image.

### Background Art

In a production site such as a factory, a position of a moving object is estimated on the basis of a captured image captured by a camera. Examples of a scheme for reducing noises generated in such a position estimation of the moving object on the basis of the captured image include those as the following.

For example, an exponential smoothing filter is applied to the captured image to an exponential smooth moving average of the captured image, and thereby, high frequency noises can be removed. Positioning results corresponding to a plurality of pixels included in any image region on the captured image can be averaged to decrease distribution of the positioning results.

PTL 1 describes that a speed is calculated on the basis of a change in coordinates of a moving object in coordinate information for a real space and a change in coordinates of the moving object captured by a camera to recognize a state of the moving object (for example, stop, low speed, or high speed).

### CITATION LIST

### Patent Literature

[PTL 1] JP 2002-074368 A

### SUMMARY

### Technical Problem

However, in the above-described scheme of applying the exponential smoothing filter to the captured image, past image information is used, and thus, the change in the speed is disadvantageously tracked slowly. In the scheme of averaging the positioning results corresponding to the plurality of pixels included in any image region, the noises cannot be effectively removed disadvantageously, for example, in a case that the noises are included entirely in the region.

Furthermore, in the technique described in PTL 1, the position and speed of the moving object cannot be calculated disadvantageously without the coordinate information for the real space as input information.

An example object of the present invention is to provide a position estimating method, a position estimating system, and a position estimating apparatus capable of appropriately estimating a position of a moving object, on the basis of a captured image.

### Solution to Problem

According to an example aspect of the present invention, a position estimating method includes obtaining an image coordinate representing an image position of a moving object in an image captured by an imaging apparatus, and converting the image coordinate for the moving object to a real space coordinate for the moving object, based on information obtained from a correspondence between real space coordinate information indicating a predetermined point in a real space and image coordinate information representing the predetermined point.

According to an example aspect of the present invention, a position estimating system includes a control apparatus configured to control moving of a moving object, an imaging apparatus configured to capture an image of the moving object, and a position estimating apparatus configured to estimate position information for the moving object, wherein the position estimating apparatus includes an obtaining section obtaining an image coordinate representing an image position of a moving object in an image captured by the imaging apparatus, and a converting section converting the image coordinate for the moving object to a real space coordinate for the moving object, based on information obtained from a correspondence between real space coordinate information indicating a predetermined point in a real space and image coordinate information representing the predetermined point.

According to an example aspect of the present invention, a position estimating apparatus includes an obtaining section configured to obtain an image coordinate representing an image position of a moving object in an image captured by an imaging apparatus, and a converting section configured to convert the image coordinate for the moving object to a real space coordinate for the moving object, based on information obtained from a correspondence between real space coordinate information indicating a predetermined point in a real space and image coordinate information representing the predetermined point.

### Advantageous Effects of Invention

According to an example aspect of the present invention, the position of the moving object can be appropriately estimated on the basis of the captured image. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a position estimating system 1 according to an example embodiment of the present invention;

FIG. 2 is a block diagram illustrating an example of a hardware configuration of a position estimating apparatus 100 according to a first example embodiment;

FIG. 3 is a block diagram illustrating an example of a configuration implemented by the position estimating apparatus 100, an imaging apparatus 200, and a control apparatus 400 in the position estimating system 1 according to the first example embodiment;

FIG. 4 is an explanatory diagram for describing projective transformation from a plane 31 to a plane 32, where the imaging apparatus 200 can capture the plane 31 with a focal length f and a moving object 300 is present on the plane 32;

FIG. 5 is a diagram illustrating concrete examples of a captured image 510 and an image 520 resulting from the projective transformation;

FIG. 6 is a diagram illustrating concrete examples of a captured image 610 and an image 620 resulting from the projective transformation in a case that the moving object 300 moves in a square like trajectory;

FIG. 7 is a diagram illustrating a flow of an operation of the position estimating apparatus 100 including a process for obtaining an association between real space coordinate information and image coordinate information according to a first concrete example;

FIG. 8 is a diagram illustrating a flow of an operation of the position estimating apparatus 100 including a process for obtaining an association between real space coordinate information and image coordinate information according to a second concrete example;

FIG. 9 is a diagram illustrating a concrete example of parameters stored in a parameter storing section 160;

FIG. 10 is a diagram for describing a flow of a process for converting on the basis of parameters stored in the parameter storing section 160 from image coordinates to real space coordinates for the moving object;

FIG. 11A is a diagram schematically illustrating a concrete example of simultaneously performing position estimations on the identical moving object 300 using captured images by a plurality of imaging apparatuses 201, 201, and FIG. 11B is diagram illustrating trajectories of real space coordinates based on the captured images by the plurality of imaging apparatuses 201, 201;

FIG. 12 is a block diagram illustrating an example of a schematic configuration of the position estimating apparatus 100 according to a second example embodiment; and

FIG. 13 is a diagram for describing a flow of a process performed by the position estimating apparatus 100 according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments according to the Present Invention

2. Configuration of System

3. First Example Embodiment
3.1. Configuration of Position Estimating Apparatus 100
3.2. Operation Example

4. Second Example Embodiment
4.1. Configuration of Position Estimating Apparatus 100
4.2. Operation Example

5. Other Embodiment Examples

### 1. Overview of Example Embodiments According to the Present Invention

Firstly, an overview of example embodiments according to the present invention will be described.

### (1) Technical Issues

In a production site such as a factory, a position of a moving object is estimated on the basis of a captured image captured by a camera. Examples of a scheme for reducing noises generated in such a position estimation of the moving object on the basis of the captured image include those as the following.

For example, an exponential smoothing filter is applied to the captured image to an exponential smooth moving average of the captured image, and thereby, high frequency noises can be removed. Positioning results corresponding to a plurality of pixels included in any image region on the captured image can be averaged to decrease distribution of the positioning results.

PTL 1 describes that a speed is calculated on the basis of a change in coordinates of a moving object in coordinate information for a real space and a change in coordinates of the moving object captured by a camera to recognize a state of the moving object (for example, stop, low speed, or high speed).

However, in the above-described scheme of applying the exponential smoothing filter to the captured image, past image information is used, and thus, the change in the speed is disadvantageously tracked slowly. In the scheme of averaging the positioning results corresponding to the plurality of pixels included in any image region, the noises cannot be effectively removed disadvantageously, for example, in a case that the noises are included entirely in the region.

Furthermore, in the technique described in PTL 1, the position and speed of the moving object cannot be calculated disadvantageously without the coordinate information for the real space as input information.

As such, an example embodiment of the example embodiment is to appropriately estimate the position of the moving object on the basis of the captured image.

### (2) Operation Example

In the example embodiments of the present invention, for example, an image coordinate is obtained that represents an image position of a moving object in an image captured by an imaging apparatus, and the image coordinate for the moving object is converted to a real space coordinate for the moving object, based on information obtained from a correspondence between real space coordinate information indicating a predetermined point in a real space and image coordinate information representing the predetermined point.

This allows the position of the moving object to be appropriately estimated on the basis of the captured image, for example. Note that the operation example described above is merely a concrete example according to the example embodiment of to the present invention, and of course, the example embodiment of the present invention is not limited to the operation example described above.

### 2. Configuration of System

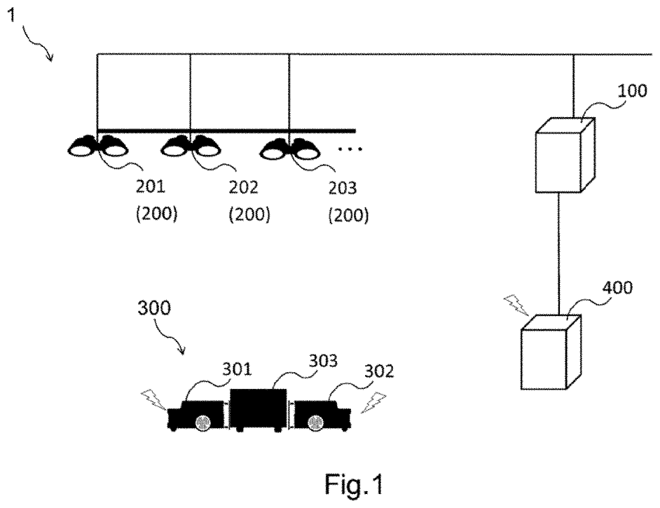

With reference to FIG. 1, an example of a configuration of a position estimating system 1 according to an example embodiment of the present invention will be described. FIG. 1 is an explanatory diagram illustrating an example of a schematic configuration of the position estimating system 1 according to an example embodiment of the present invention.

With reference to FIG. 1, the position estimating system 1 includes a position estimating apparatus 100, a plurality of imaging apparatuses 201, 202, and 203 (simply referred to as the “imaging apparatus 200” in a case of no special reason for being distinguished), a moving object 300, and a control apparatus 400.

The position estimating apparatus 100 uses information relating to captured images captured by the plurality of imaging apparatuses 200 to estimate a position of the moving object 300. Concrete processing of the position estimating apparatus 100 will be described later.

The imaging apparatus 200 is an apparatus capturing an image in a field where the moving object 300 can move. The imaging apparatus 200 is configured to include, for example, a depth camera and/or a stereo camera. The depth camera is a camera capable of capturing a depth image that each of pixel values of the image indicates a distance from the camera to an object. The stereo camera is a camera capable of measurement for depth direction of an object by imaging the object in a plurality of directions different from each other by using a base camera and a reference camera.

Each imaging apparatus 200 is communicably connected to the position estimating apparatus 100. The imaging apparatus 200 captures images in the field at a prescribed interval (or a prescribed sampling period), and transmits image data to the position estimating apparatus 100.

The moving object 300 includes, for example, two transfer robots 301 and 302, and an article 303. The transfer robot 301 is a cooperative transfer robot that transfers the article 303 in cooperation with the other robot 302. Specifically, the transfer robots 301 and 302 hold the article 303 therebetween in opposite directions, and move in a state of holding the article 303 to transfer the article 303. The transfer robots 301 and 302 are configured to be communicable with the control apparatus 400, and move on the basis of a control command (control information) from the control apparatus 400.

The control apparatus 400 transmits the control commands to the transfer robots 301 and 302 included in the moving object 300 on the basis of, for example, position information of the moving object 300 estimated by the position estimating apparatus 100.

### 3. First Example Embodiment

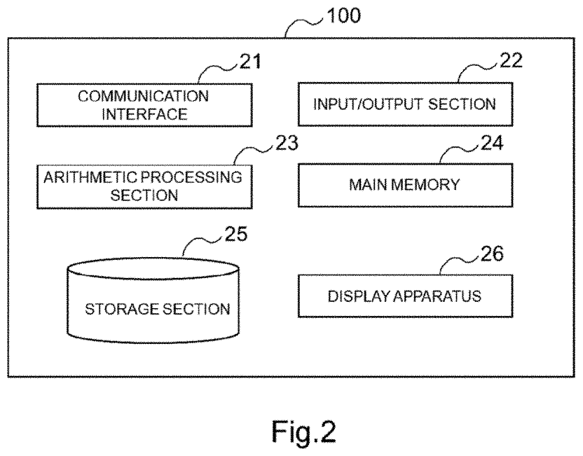

Subsequently, a position estimating apparatus 100 according to a first example embodiment will be described with reference to FIGS. 2 to 11B.

### 3.1. Configuration of Position Estimating Apparatus 100

FIG. 2 is a block diagram illustrating an example of a hardware configuration of the position estimating apparatus 100 according to the first example embodiment. With reference to FIG. 2, the position estimating apparatus 100 includes a communication interface 21, an input/output section 22, an arithmetic processing section 23, a main memory 24, and a storage section 25.

The communication interface 21 transmits and receives data to and from an external apparatus. For example, the communication interface 21 communicates with the external apparatus via a wired communication path or a radio communication path.

The arithmetic processing section 23 is, for example, a central processing unit (CPU), a graphics processing unit (GPU), or the like. The main memory 24 is, for example, a random access memory (RAM), a read only memory (ROM), or the like. The storage section 25 is, for example, a hard disk drive (HDD), a solid state drive (SSD), a memory card, or the like. The storage section 25 may be a memory such as a RAM and a ROM.

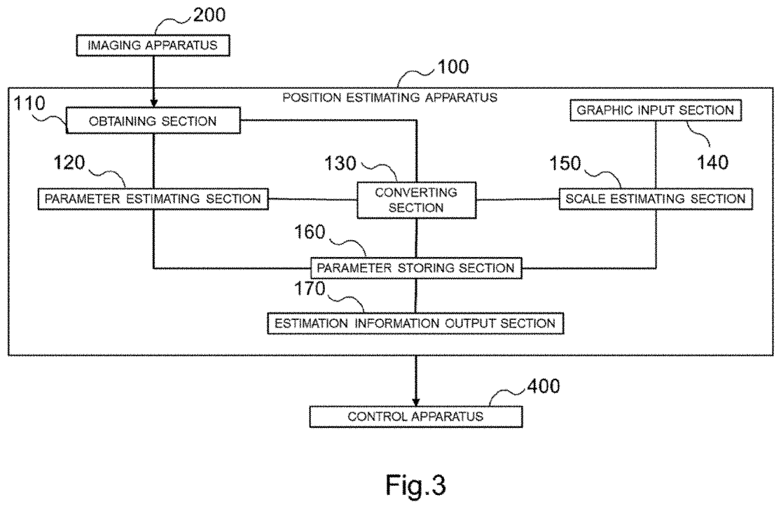

The position estimating apparatus 100 reads programs for position estimation stored in the storage section 25 onto the main memory 24 and executes the programs by the arithmetic processing section 23 to implement a functional section as illustrated in FIG. 3, for example. These programs may be read onto the main memory 24 and executed, or may be executed without being read onto the main memory 24. The main memory 24 or the storage section 25 also functions to store information or data held by constituent components included in the position estimating apparatus 100.

The programs described above can be stored by use of various types of non-transitory computer readable media to be supplied to a computer. The non-transitory computer readable media includes various types of tangible storage media. Examples of the non-transitory computer readable media include a magnetic recording medium (for example, a flexible disk, a magnetic tape, a hard disk drive), a magneto-optical recording medium (for example, a magneto-optical disk), a compact disc-ROM (CD-ROM), a CD-recordable (CD-R), a CD-rewritable (CD-R/W), a semiconductor memory (for example, a mask ROM, a programmable ROM (PROM), an erasable PROM (EPROM), a flash ROM, and a RAM. The programs may be supplied to a computer by use of various types of transitory computer readable media. Examples of the transitory computer readable media include electrical signals, optical signals, and electromagnetic waves. The transitory computer readable media can supply a program to a computer via a wired communication path such as electrical wires and optical fibers, or a radio communication path.

A display apparatus 26 is an apparatus displaying a screen corresponding to rendering data processed by the arithmetic processing section 23, such as a liquid crystal display (LCD), a cathode ray tube (CRT) display, and a monitor.

FIG. 3 is a block diagram illustrating an example of a configuration implemented by the position estimating apparatus 100, the imaging apparatus 200, and the control apparatus 400 in the position estimating system 1 according to the first example embodiment. With reference to FIG. 3, the position estimating apparatus 100 includes an obtaining section 110, a parameter estimating section 120, a converting section 130, a graphic input section 140, a scale estimating section 150, a parameter storing section 160, and an estimation information output section 170.

### 3.2. Operation Example

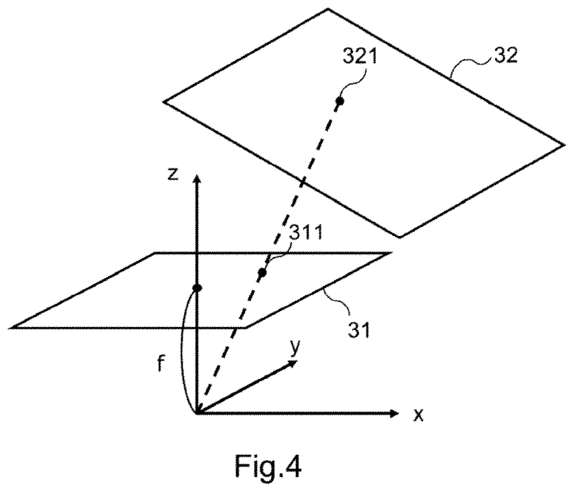

Next, an operation example according to the first example embodiment will be described with reference to FIGS. 4 to 11B.

According to the first example embodiment, the position estimating apparatus 100 (the obtaining section 110) obtains image coordinates representing an image position of the moving object 300 in the captured image captured by the imaging apparatus 200. The position estimating apparatus 100 (the converting section 130) converts the image coordinates for the moving object 300 to the real space coordinates for the moving object 300, based on the information obtained from the correspondence between the real space coordinate information indicating a predetermined point in the real space and the image coordinate information representing the predetermined point.

Here, the information obtained from the correspondence between the real space coordinate information and the image coordinate information includes, for example, parameters stored in the parameter storing section 160. In other words, the position estimating apparatus 100 (the converting section 130) converts the image coordinates for the moving object 300 to the real space coordinates for the moving object 300 on the basis of the parameters stored in the parameter storing section 160.

According to the first example embodiment, the control apparatus 400 specifies a path along which the moving object 300 moves on the basis of the real space coordinates for the moving object 300 to indicate to the moving object 300 an instruction to move along the specified path.

### (1) Real Space Coordinate Information

The real space coordinate information represents coordinates indicating a predetermined point in the real space. The real space coordinate information is associated with image coordinate information using a method as described later, for example.

The real space coordinate information is information of the real space coordinates for a plurality of points through which the moving object 300 moves along a predetermined moving path. The predetermined moving path is a path present in a region where one or more imaging apparatuses 200 can capture the moving object 300. The real space coordinate information is associated with the image coordinate information in a way as described below, for example.

Real Space Coordinate Information Specified Based on Moving Path

Information relating to the predetermined moving path is input from the control apparatus 400 controlling the moving object 300 to the position estimating apparatus 100 (the graphic input section 140). As an example, in a case of the path along which the moving object moves in a circular pattern, the control apparatus 400 inputs to the position estimating apparatus 100 the real space coordinate information of the path so that the moving object 300 moves in a circular pattern. To be more specific, the control apparatus 400 inputs the real space coordinate information of information of the path along which the moving object 300 is to move. The moving object 300 moving along the moving path in a circular causes the position estimating apparatus 100 (for example, the parameter estimating section 120 and the scale estimating section 150) to associate the real space coordinate information with the image coordinate information. For example, the position estimating apparatus 100 (for example, the parameter estimating section 120 and the scale estimating section 150) associates the real space coordinate information input as the path along which the moving object 300 is to move with the image coordinates for the moving object in the captured image captured by the imaging apparatus 200.

Real Space Coordinate Information Based on Information of Position Detecting Apparatus

The real space coordinate information is information of a plurality of real space coordinates based on position detection of the moving object by a position detecting apparatus, and is associated with the image coordinate information in a way as described below, for example. For example, the position estimating apparatus 100 (for example, the parameter estimating section 120 and the scale estimating section 150) compares the real space coordinate information specified by the position detecting apparatus with the image coordinate information to associate the real space coordinate information with the image coordinate information. The method for associating the real space coordinate information with the image coordinate information by the position estimating apparatus 100 (for example, the parameter estimating section 120 and the scale estimating section 150) will be described later.

The position detecting apparatus may be, for example, a stereo camera included in the imaging apparatus 200. In other words, the real space coordinate information may represent coordinates indicating a predetermined point in a range image captured by the stereo camera (range image coordinates).

Note that the position detecting apparatus is not limited to the stereo camera described above, and may be any apparatus having a function capable of detecting the real space coordinates in the three-dimensional space.

### (2) Parameters

The information obtained from the correspondence between the real space coordinate information and the image coordinate information (the parameters stored in the parameter storing section 160) includes projective transformation parameters for projective transformation from the captured image into a plane image in which the moving object 300 is present.

(2-1) Projective Transformation

FIG. 4 is an explanatory diagram for describing projective transformation from a plane 31 to a plane 32, where the imaging apparatus 200 can capture the plane 31 with a focal length f and a moving object 300 is present on the plane 32. With reference to FIG. 4, image coordinates 311 in the plane 31 are represented by (x, y, z). Image coordinates 312 in the plane 32 are represented by (x′, y′, z′). Here, when f=1 for the purpose of convenience and an z-coordinate on the plane 32 is given by z=a₀x+b₀y+c₀, the image coordinates 311 are projectively transformed to the image coordinates 312 as expressed by equations below.

### [Math. 1]

$$\{ \begin{matrix}{x}^{′} = \frac{x}{{a}_{0} x + {b}_{0} y + {c}_{0}} \\ {y}^{′} = \frac{y}{{a}_{0} x + {b}_{0} y + {c}_{0}}\end{matrix}$$

Here, the projective transformation parameters are (a₀, b₀, c₀) and are determined in a way as described below, for example. As a first determination method, the moving object 300 is made to move through three predefined points, and the image coordinates for the moving object 300 at each point are used to be able to determine the parameters for the projective transformation. The projective transformation parameters can be determined by optimization by the least square method or the like using the image coordinates for the moving object 300 at each point.

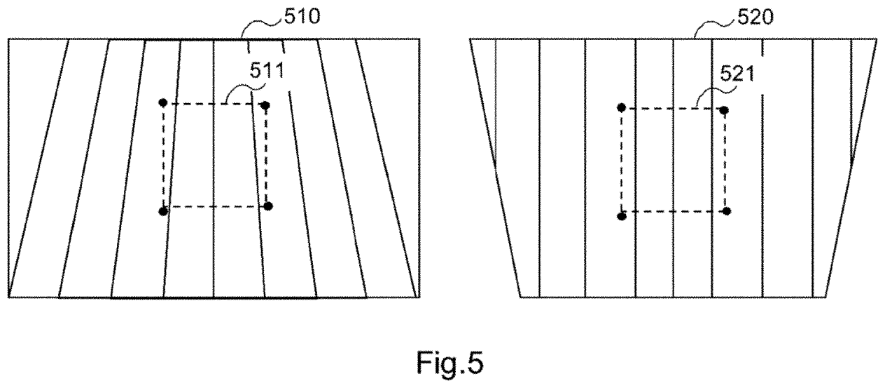

FIG. 5 is a diagram illustrating concrete examples of a captured image 510 and an image 520 resulting from the projective transformation. With reference to FIG. 5, in the captured image 510, grooves in a region 511 surrounded by a dotted line are not rendered in parallel, because the camera is installed diagonally with respect to a floor surface, for example. In contrast, in the image 520 subjected to the projective transformation, transformation to a viewpoint perpendicular to the floor surface is performed, and then, grooves are rendered in parallel in a region 521 surrounded by a dotted line.

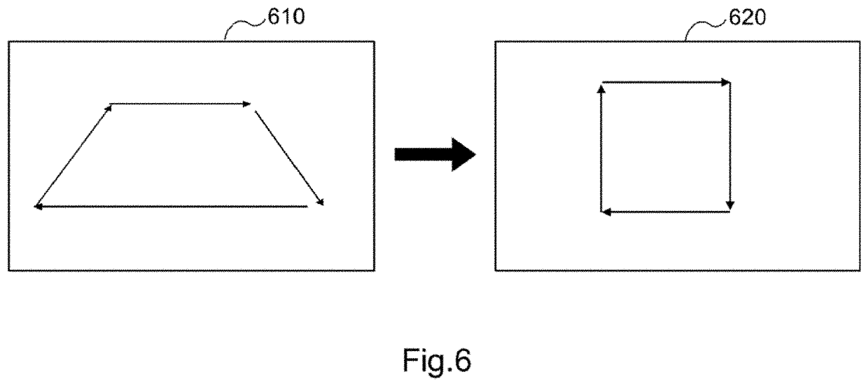

FIG. 6 is a diagram illustrating concrete examples of a captured image 610 and an image 620 resulting from the projective transformation in a case that the moving object 300 moves in a square like trajectory. With reference to FIG. 6, in the captured image 610, the moving path of the moving object 300 is substantially trapezoidal, because the camera is installed diagonally with respect to the floor surface, for example. In contrast, in the image 620 resulting from the projective transformation, the moving path of the moving object 300 is square correspondingly to an actual moving.

Obtaining Projective Transformation Parameters

The projective transformation parameters are obtained in a way as described below, for example.

Firstly, assume that the imaging apparatus 200 captures an image of the moving object 300, and outputs a captured image by the base camera of the stereo camera included in the imaging apparatus 200 and a range image by the stereo camera to the position estimating apparatus 100.

In this case, the position estimating apparatus 100 uses image coordinates (x, y) for the captured image and range image coordinates (X, Y, Z) for the range image corresponding to the captured image to find an equation Z=a₀x+b₀y+c₀ for a plane on which the moving object 300 is present by use of a combination of (x, y, Z). By finding such an equation Z=a₀x+b₀y+c₀ for each of three points where the moving object 300 is present, the projective transformation parameters (a₀, b₀, c₀) can be obtained.

Note that in a case that the imaging apparatus 200 includes a depth camera, values of the range image coordinates in a Z-axis direction may be depth data obtained by the depth camera, for example.

As described above, the position estimating apparatus 100 can obtain the projective transformation parameters (a₀, b₀, c₀) for the projective transformation from the image coordinates (x, y) into the plane image in which the moving object is present.

(2-2) Scale Adjustment Parameters

Adjustment of Shift Amount

The information obtained from the correspondence further includes scale transformation parameters for transforming a scale for the moving object 300 on the image subjected to the projective transformation into a scale for the moving object 300 in the real space. Specifically, the scale transformation parameters include a shift amount adjustment parameter and a size adjustment parameter as described below.

(Shift Amount Adjustment Parameter)

The shift amount adjustment parameter is a parameter for adjusting a shift amount for the moving object 300 on the image subjected to the projective transformation to a shift amount for the moving object 300 in the real space. The shift amount adjustment parameter can be referenced to adjust a shift amount corresponding to one pixel on the image resulting from the projective transformation to a shift amount (by the meter) for the real space coordinate in the real space, for example.

Such a correspondence in the shift amount is different for each of two coordinate axes defining a plane on which the moving object 300 moves. As such, the information obtained from the correspondence may include the shift amount adjustment parameter for each of two coordinate axes defining the plane on which the moving object 300 moves.

(Size Adjustment Parameter)

The size adjustment parameter is a parameter for adjusting a size of the image subjected to the projective transformation to a size in the real space. The size adjustment parameter can be referenced to adjust a size corresponding to one pixel of the image resulting from the projective transformation to a size (by the meter) for the real space coordinate in the three-dimensional space, for example.

Such a correspondence in the size is different for each of two coordinate axes defining a plane on which the moving object 300 moves. As such, the information obtained from the correspondence may include the size adjustment parameter for each of two coordinate axes defining the plane on which the moving object 300 moves.

### (3) Method for Associating Real Space Coordinate Information with Image Coordinate Information

Next, the method for associating the real space coordinate information with the image coordinate information will be described as below.

### First Concrete Example

In a first concrete example, assume a case that the real space coordinate information indicating the predetermined position includes the real space coordinates for a plurality of points through which the moving object 300 moves along the predetermined moving path. Here, the predetermined moving path is a path present in a region where one or more imaging apparatuses 200 can capture the moving object 300.

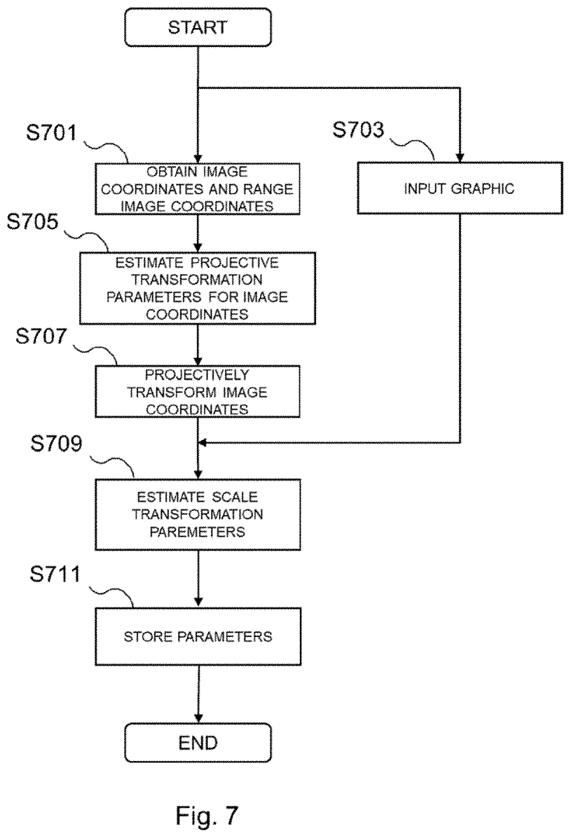

FIG. 7 is a diagram illustrating a flow of an operation of the position estimating apparatus 100 including a process for obtaining the association between the real space coordinate information and the image coordinate information according to the first concrete example.

With reference to FIG. 7, the moving object 300 moves in accordance with information for a graphic indicated by the control apparatus 400. The imaging apparatus 200 captures an image of the moving object 300 during moving.

In step S701, the position estimating apparatus 100 (the obtaining section 110) obtains the image coordinates and the range image coordinates from the imaging apparatus 200. Then, the process proceeds to step S705. Here, the image coordinates represent the coordinates in the captured image by the base camera of the stereo camera included in the imaging apparatus 200, for example, as described above. The range image coordinates represent the coordinates on the range image by the stereo camera (the imaging apparatus 200), for example, as described above.

In step S703, the position estimating apparatus 100 (the graphic input section 140) receives the information for the graphic indicating the moving path of the moving object 300 input from the control apparatus 400, for example. Then, the process proceeds to step S709. Input of such information for the graphic allows the position estimating apparatus 100 (the scale estimating section 150) to obtain the real space coordinates for a plurality of points through which the moving object 300 moves along the moving path indicated by the graphic.

In step S705, the position estimating apparatus 100 (the parameter estimating section 120) uses the image coordinates and the range image coordinates to estimate the projective transformation parameters for transforming the image coordinates into image coordinates on the plane image in which the moving object 300 is present. Specifically, the equation Z=a₀x+b₀y+c₀ for the plane on which the moving object 300 is present is found by use of the combination of (x, y, Z). By finding such an equation Z=a₀x+b₀y+c₀ for each of three points where the moving object 300 is present, the projective transformation parameters (a₁, b₁, c₁) can be obtained. Then, the process proceeds to step S707.

In step S707, the position estimating apparatus 100 (the converting section 130) uses the estimated projective transformation parameters (a₀, b₀, c₀) to transform the image coordinates into image coordinates on the plane image in which the moving object 300 is present. Then, the process proceeds to step S709.

In step S709, the position estimating apparatus 100 (the scale estimating section 150) compares the image coordinates on the plane image in which the moving object 300 is present with the real space coordinates for a plurality of points through which the moving object moves along the moving path indicated by the graphic to estimate the scale transformation parameter.

Specifically, the position estimating apparatus 100 (the scale estimating section 150) determines, as estimation values, the image coordinates on the plane image in which the moving object 300 is present. The position estimating apparatus 100 (the scale estimating section 150) determines, as correct solution values, the real space coordinates for the plurality of points through which the moving object 300 moves along the moving path indicated by the graphic. Then, the position estimating apparatus 100 (the scale estimating section 150) can perform the shift amount adjustment and the size adjustment for obtaining the correct solution values from the estimation values to estimate the shift amount adjustment parameter and the size adjustment parameter. Then the process proceeds to step S711.

In step S711, the position estimating apparatus 100 (the parameter storing section 160) associates the projective transformation parameters estimated in step S707 with the scale transformation parameters estimated in step S709 and stores these parameters, and then, terminates the process illustrated in FIG. 7.

According to the process illustrated in the FIG. 7, the real space coordinates for the plurality of points through which the moving object 300 moves along the predetermined moving path can be used to obtain the projective transformation parameters and the scale transformation parameters.

### Second Concrete Example

In a second concrete example, assume a case that the real space coordinate information indicating the predetermined position includes a plurality of real space coordinates based on the position detection of the moving object 300 by the position detecting apparatus. In the second concrete example, assume a case that the position detecting apparatus is the stereo camera included in the imaging apparatus 200.

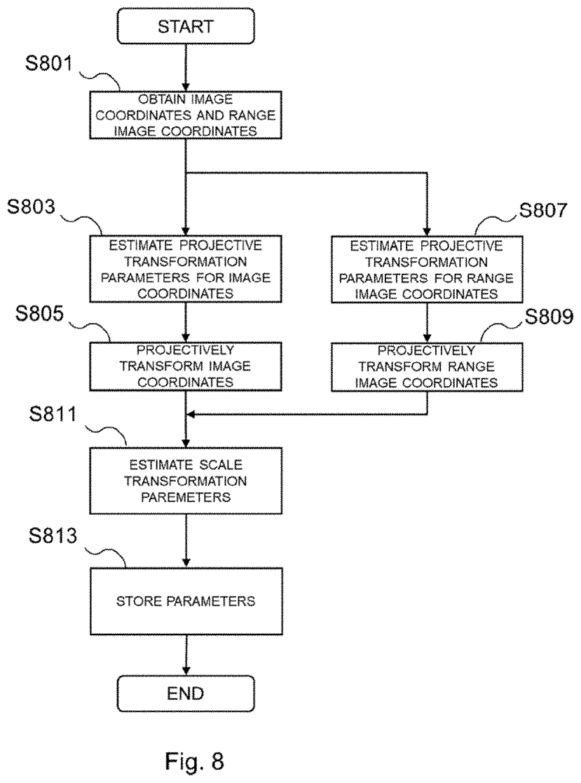

FIG. 8 is a diagram illustrating a flow of an operation of the position estimating apparatus 100 including a process for obtaining the association between the real space coordinate information and the image coordinate information according to the second concrete example.

In step S801, the position estimating apparatus 100 (the obtaining section 110) obtains the image coordinates and the range image coordinates from the imaging apparatus 200. Then, the process proceeds to step S803 and step S807.

In step S803, the position estimating apparatus 100 (the parameter estimating section 120) uses the image coordinates (x, y, z) and the range image coordinates (X, Y, Z) to estimate the projective transformation parameters for transforming the image coordinates (x, y, z) into image coordinates on the plane image in which the moving object 300 is present. Specifically, the equation Z=a₀x+b₀y+c₀ for the plane on which the moving object 300 is present is found by use of the combination of (x, y, Z). By finding such an equation Z=a₀x+b₀y+c₀ for each of three points where the moving object 300 is present, the projective transformation parameters (a₀, b₀, c₀) can be obtained. Then, the process proceeds to step S805.

In step S805, the position estimating apparatus 100 (the converting section 130) uses the estimated projective transformation parameters (a₀, b₀, c₀) to transform the image coordinates into image coordinates on the plane image in which the moving object 300 is present. Then, the process proceeds to step S811.

In step S807, the position estimating apparatus 100 (the parameter estimating section 120) uses the range image coordinates to estimate the projective transformation parameters for transforming the rage image coordinates into range image coordinates on the plane on which the moving object 300 is present. Specifically, an equation Z=a₁x+b₁y+c₁ for the plane on which the moving object 300 is present is found by use of a combination of (X, Y, Z). By finding such an equation Z=a₁X+b₁Y+c₁ for each of three points where the moving object 300 is present, the projective transformation parameters (a₁, b₁, c₁) can be obtained. Then, the process proceeds to step S809.

In step S809, the position estimating apparatus 100 (the converting section 130) uses the estimated projective transformation parameters (a₁, b₁, c₁) to transform the range image coordinates into range image coordinates on the plane image in which the moving object 300 is present. Then, the position estimating apparatus 100 (the converting section 130) outputs the range image coordinates on the plane image in which the moving object 300 is present as the plurality of real space coordinates based on the position detection of the moving object by the position detecting apparatus to the scale estimating section 150. Then, the process proceeds to step S811.

In step S801, the position estimating apparatus 100 (the scale estimating section 150) compares the image coordinates on the plane image in which the moving object 300 is present with the plurality of real space coordinates based on the position detection of the moving object by the position detecting apparatus to estimate the scale transformation parameter. Specifically, the position estimating apparatus 100 (the scale estimating section 150) determines, as estimation values, the image coordinates on the plane image in which the moving object 300 is present. The position estimating apparatus 100 (the scale estimating section 150) determines, as correct solution values, the plurality of real space coordinates based on the position detection of the moving object by the position detecting apparatus. Then, the position estimating apparatus 100 (the scale estimating section 150) can perform the shift amount adjustment and the size adjustment for obtaining the correct solution values from the estimation values to estimate the shift amount adjustment parameter and the size adjustment parameter. Then the process proceeds to step S813.

In step S813, the position estimating apparatus 100 (the parameter storing section 160) associates the projective transformation parameters estimated in step S803 with the scale transformation parameters estimated in step S811 and stores these parameters.

According to the process illustrated in the FIG. 8, the plurality of real space coordinates based on the position detection of the moving object by the position detecting apparatus can be used to obtain the projective transformation parameters and the scale transformation parameters.

### (4) Storing Parameters

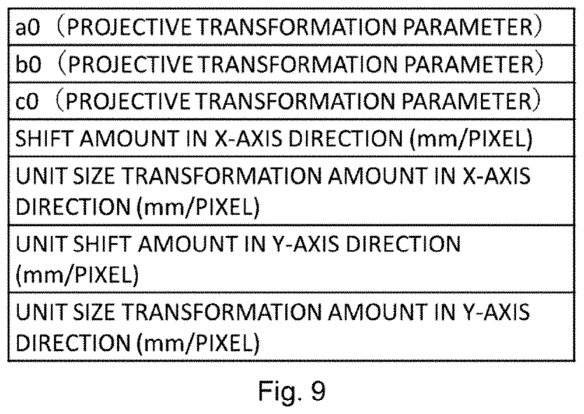

FIG. 9 is a diagram illustrating a concrete example of the parameters stored in the parameter storing section 160.

With reference to FIG. 9, real number values of three values (a₀, b₀, c₀) constituting the projective transformation parameters, a unit shift amount in an X-axis direction, a unit size transformation amount in the X-axis direction, a unit shift amount in a Y-axis direction, and a unit size transformation amount in the Y-axis direction are associated with each other and stored in the parameter storing section 160. The parameters stored in the parameter storing section 160 being used in this way allows the real space coordinates to be estimated with high accuracy from the coordinate information of the captured image obtained by the imaging apparatus 200.

### (5) Position Estimation

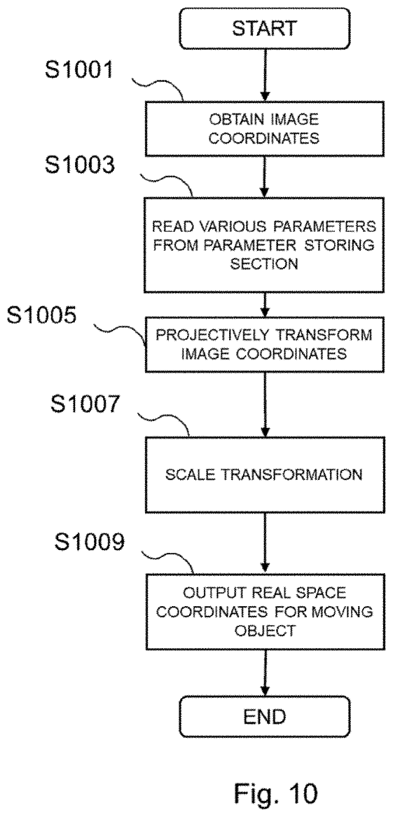

FIG. 10 is a diagram for describing a flow of a process for converting on the basis of the parameters stored in the parameter storing section 160 from the image coordinates to the real space coordinates for the moving object.

With reference to FIG. 10, in step S1001, the position estimating apparatus 100 (the obtaining section 110) obtains image coordinates representing an image position of the moving object 300 in the captured image captured by the imaging apparatus 200. Then, the process proceeds to step S1003.

In step S1003, the position estimating apparatus 100 (the converting section 130) reads various parameters from the parameter storing section 160. Then, the process proceeds to step S1005.

In step S1005, the position estimating apparatus 100 (the converting section 130) performs the projective transformation on the image coordinates by using the projective transformation parameters to obtain image coordinates on the plane image in which the moving object 300 is present. Then, the process proceeds to step S1007.

In step S1007, the position estimating apparatus 100 (the converting section 130) performs the scale transformation on the image coordinates on the plane on which the moving object 300 is present by using the scale transformation parameters to estimate the real space coordinates for the moving object. Then, the process proceeds to step S1009.

In step S1009, the position estimating apparatus 100 (the estimation information output section 170) outputs estimation information for the real space coordinates for the moving object to the control apparatus 400.

According to the process illustrated in the FIG. 8, the parameters stored in the parameter storing section 160 can be referenced to convert the image coordinates representing the image position of the moving object in the captured image to the real space coordinates for the moving object.

### (6) Example Alterations

The first example embodiment is not limited to the concrete examples described above and can be variously modified.

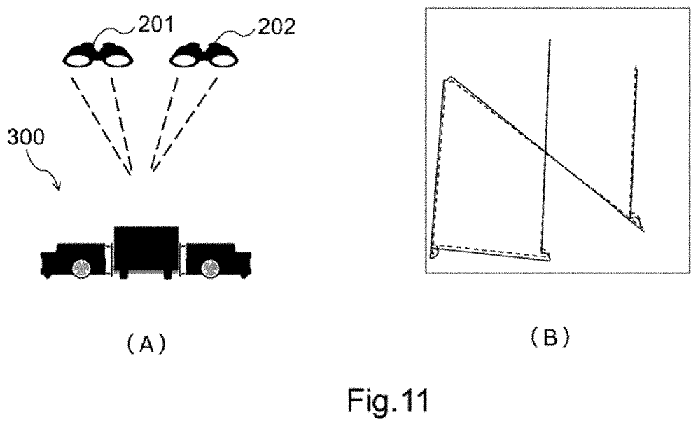

FIG. 11A is a diagram schematically illustrating a concrete example of simultaneously performing the position estimations on the identical moving object 300 using captured images by a plurality of imaging apparatuses 201, 201, and FIG. 11B is diagram illustrating trajectories of real space coordinates based on the captured images by the plurality of imaging apparatuses 201, 201.

With reference to FIG. 11B, for example, the trajectory of the real space coordinates based on the captured image by the imaging apparatus 201 is indicated by a solid line, and the trajectory of the real space coordinate based on the captured image by the imaging apparatus 202 is indicated by a broken line. As is obvious from FIG. 11B, for example, as a moving direction of the moving object 300 changes, a difference may be generated between the trajectories of the moving object 300 indicated by the solid line and the broken line. This is because a difference between each of the imaging apparatuses 201 and 202 and the real space coordinates is generated, for example.

As such, the parameter storing section 160 may further include parameters for adjusting a difference in the position of the moving object 300 on the images captured by the plurality of imaging apparatuses 201 and 202.

Obtaining of the position adjustment parameters described above will be described. For example, the moving object 300 is located at a position which can be simultaneously captured by two imaging apparatuses 201 and 202, and moving object 300 is captured by the imaging apparatuses 201 and 202. In other words, the moving object 300 moves along the moving path that can be captured by both the imaging apparatuses 201 and 202. The captured images by these two imaging apparatuses 201 and 202 are used to obtain the position adjustment parameters by a process as described below, for example.

Firstly, the captured images by the imaging apparatuses 201 and 202 are subjected to the projective transformation and the scale transformation on the basis of the parameters obtained according to the first example embodiment to obtain a difference in the position of the moving object 300 (a position and an angle of the moving object 300) on the images resulting from the transformations.

Next, the image resulting from the projective transformation and the scale transformation of the captured image by, for example, the imaging apparatus 201 is translated and rotated so that the difference in the position of the moving object 300 (the position and the angle of the moving object 300) is zero. Such a parameter for translating and rotating the image can be obtained as the position adjustment parameter.

Thus, the position estimating apparatus 100 (the converting section 130) can translate and rotate the image resulting from the projective transformation and the scale transformation of the captured image by the imaging apparatus 202 on the basis of the position adjustment parameters to reduce the difference possibly generated in the real space coordinates estimated on the basis of the captured images by the imaging apparatuses 201 and 202.

### 4. Second Example Embodiment

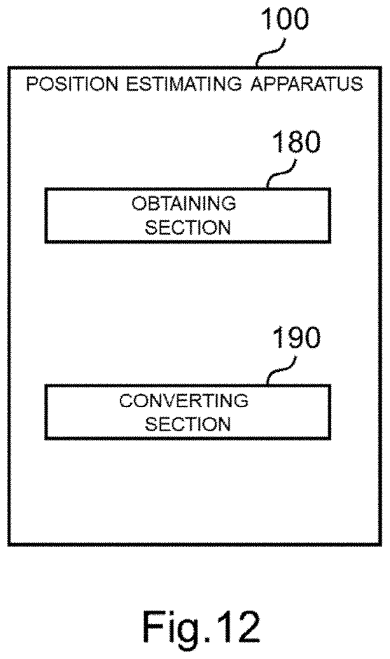

Subsequently, a second example embodiment will be described with reference to FIG. 12. The above-described first example embodiment is a concrete example embodiment, whereas the second example embodiment is a more generalized example embodiment.

### 4.1. Configuration of Position Estimating Apparatus 100

FIG. 12 is a block diagram illustrating an example of a schematic configuration of a position estimating apparatus 100 according to a second example embodiment. With reference to FIG. 12, the position estimating apparatus 100 includes an obtaining section 180 and a converting section 190.

The obtaining section 180 and the converting section 190 may be implemented with one or more processors, a memory (e.g., a nonvolatile memory and/or a volatile memory), and/or a hard disk. The obtaining section 180 and the converting section 190 may be implemented with the same processor or may be implemented with separate processors. The memory may be included in the one or more processors or may be provided outside the one or more processors.

### 4.2. Operation Example

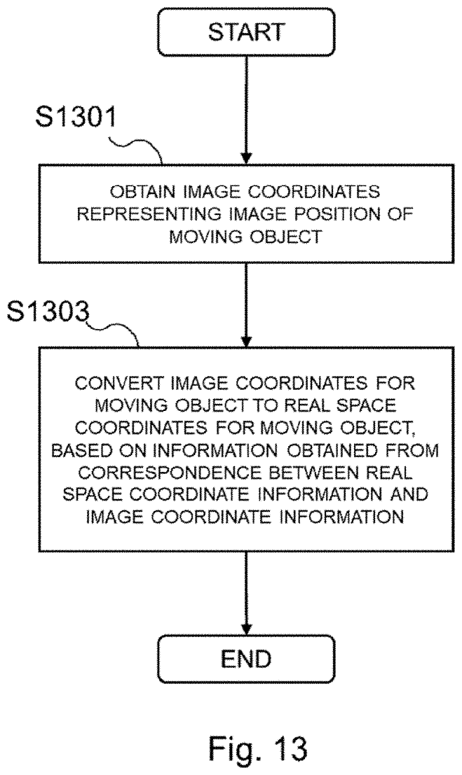

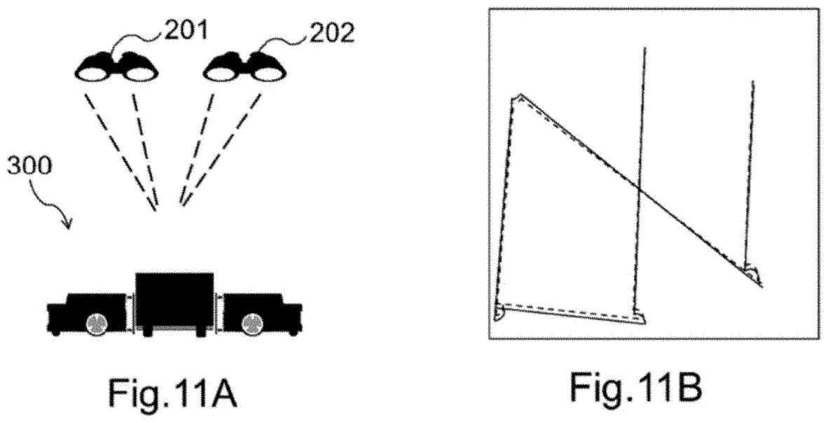

An operation example according to the second example embodiment will be described. FIG. 13 is a diagram for describing a flow of a process performed by the position estimating apparatus 100 according to the second example embodiment.

According to the second example embodiment, the position estimating apparatus 100 (the obtaining section 180) obtains image coordinates representing an image position of a moving object in a captured image captured by the imaging apparatus (step S1301). Then, the position estimating apparatus 100 (the converting section 190) converts the image coordinates for the moving object to real space coordinates for the moving object, based on information obtained from a correspondence between real space coordinate information indicating a predetermined point in a real space and image coordinate information representing the predetermined point (S1303).

Relationship with First Example Embodiment

As an example, the obtaining section 180 and the converting section 190 in the second example embodiment may perform the operations of the obtaining section 110 and the converting section 130 in the first example embodiment, respectively. In this case, the descriptions of the first example embodiment may be applicable to the second example embodiment.

Note that the second example embodiment is not limited to this example.

The second example embodiment has been described above. According to the second example embodiment, the position of the moving object can be appropriately estimated on the basis of the captured image, for example.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the position estimating apparatus described above is not limited to be located away from the control apparatus, and may be provided within the control apparatus, for example. The steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the obtaining section and/or the converting section) of the position estimating apparatus described in the Specification (e.g., one or more apparatuses (or units) among a plurality of apparatuses (or units) constituting the position estimating apparatus, or a module for one of the plurality of apparatuses (or units)) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

A position estimating method comprising:

obtaining an image coordinate representing an image position of a moving object in an image captured by an imaging apparatus; and

converting the image coordinate for the moving object to a real space coordinate for the moving object, based on information obtained from a correspondence between real space coordinate information indicating a predetermined point in a real space and image coordinate information representing the predetermined point.

### (Supplementary Note 2)

The position estimating method according to supplementary note 1, wherein the information obtained from the correspondence includes projective transformation parameters for projective transformation from the captured image into a plane image in which the moving object is present.

### (Supplementary Note 3)

The position estimating method according to supplementary note 2, wherein the information obtained from the correspondence further includes scale transformation parameters for transforming a scale for the moving object on the image subjected to the projective transformation into a scale for the moving object in the real space.

### (Supplementary Note 4)

The position estimating method according to supplementary note 3, wherein the scale transformation parameters include a parameter for adjusting a shift amount for the moving object on the image subjected to the projective transformation to a shift amount for the moving object in the real space.

### (Supplementary Note 5)

The position estimating method according to supplementary note 3 or 4, wherein the scale transformation parameters further include a parameter for adjusting an image size for the moving object on the image subjected to the projective transformation into a size for the moving object in the real space.

### (Supplementary Note 6)

The position estimating method according to any one of supplementary notes 3 to 5, wherein the scale transformation parameters include a parameter for transforming a scale for the moving object on the image subjected to the projective transformation into a scale for the moving object in the real space for two coordinate axes defining a plane on which the moving object moves.

### (Supplementary Note 7)

The position estimating method according to any one of supplementary notes 1 to 6, wherein the real space coordinate information indicating the predetermined position is information of real space coordinates for a plurality of points through which the moving object moves along a predetermined moving path.

### (Supplementary Note 8)

The position estimating method according to supplementary note 7, wherein the predetermined moving path is a path present in a region where a plurality of imaging apparatuses are configured to capture the moving object.

### (Supplementary Note 9)

The position estimating method according to supplementary note 8, wherein the information obtained from the correspondence further includes a parameter for adjusting a difference in a position of the moving object on images captured by the plurality of imaging apparatuses.

### (Supplementary Note 10)

The position estimating method according to any one of supplementary notes 1 to 6, wherein the real space coordinate information indicating the predetermined position is information of a plurality of real space coordinates based on position detection of the moving object by a position detecting apparatus.

### (Supplementary Note 11)

The position estimating method according to supplementary note 10, wherein the position detecting apparatus is a stereo camera included in the imaging apparatus.

### (Supplementary Note 12)

A position estimating system comprising:

a control apparatus configured to control moving of a moving object;

an imaging apparatus configured to capture an image of the moving object; and

a position estimating apparatus configured to estimate position information for the moving object, wherein

the position estimating apparatus includes

an obtaining section obtaining an image coordinate representing an image position of a moving object in an image captured by the imaging apparatus, and

a converting section converting the image coordinate for the moving object to a real space coordinate for the moving object, based on information obtained from a correspondence between real space coordinate information indicating a predetermined point in a real space and image coordinate information representing the predetermined point.

### (Supplementary Note 13)

The position estimating system according to supplementary note 12, wherein the control apparatus is configured to specify a path along which the moving object moves based on the real space coordinate for the moving object.

### (Supplementary Note 14)

The position estimating system according to supplementary note 13, wherein the control apparatus is configured to indicate to the moving object an instruction to move along the specified path.

### (Supplementary Note 15)

The position estimating system according to any one of supplementary notes 12 to 14, wherein the imaging apparatus is equipped with a stereo camera including a base camera and a reference camera.

### (Supplementary Note 16)

The position estimating system according to supplementary note 15, wherein the captured image is an image captured by the reference camera.

### (Supplementary Note 17)

The position estimating system according to supplementary note 15 or 16, wherein the imaging apparatus is configured to transmit a range image obtained by the stereo camera to the position estimating apparatus.

### (Supplementary Note 18)

A position estimating apparatus comprising:

an obtaining section configured to obtain an image coordinate representing an image position of a moving object in an image captured by an imaging apparatus; and

a converting section configured to convert the image coordinate for the moving object to a real space coordinate for the moving object, based on information obtained from a correspondence between real space coordinate information indicating a predetermined point in a real space and image coordinate information representing the predetermined point.

### INDUSTRIAL APPLICABILITY

In the position estimating system, the position of the moving object can be appropriately estimated on the basis of the captured image.

### REFERENCE SIGNS LIST

1 Position Estimating System
100 Position Estimating Apparatus
110, 180 Obtaining Section
120 Parameter Estimating Section
130, 190 Converting Section
140 Graphic Input Section
150 Scale Estimating Section
160 Parameter Storing Section
170 Estimation Information Output Section
200, 201, 202, 203 Imaging Apparatus
300 Moving Object
400 Control Apparatus

What is claimed is:

1. A position estimating method comprising:
obtaining an image coordinate representing an image position of a moving object in an image captured by an imaging apparatus; and
converting the image coordinate for the moving object to a real space coordinate for the moving object, based on information obtained from a correspondence between real space coordinate information indicating a predetermined point in a real space and image coordinate information representing the predetermined point.

2. The position estimating method according to claim 1, wherein the information obtained from the correspondence includes projective transformation parameters for projective transformation from the captured image into a plane image in which the moving object is present.

3. The position estimating method according to claim 2, wherein the information obtained from the correspondence further includes scale transformation parameters for transforming a scale for the moving object on the image subjected to the projective transformation into a scale for the moving object in the real space.

4. The position estimating method according to claim 3, wherein the scale transformation parameters include a parameter for adjusting a shift amount for the moving object on the image subjected to the projective transformation to a shift amount for the moving object in the real space.

5. The position estimating method according to claim 3, wherein the scale transformation parameters further include a parameter for adjusting an image size for the moving object on the image subjected to the projective transformation into a size for the moving object in the real space.

6. The position estimating method according to claim 3, wherein the scale transformation parameters include a parameter for transforming a scale for the moving object on the image subjected to the projective transformation into a scale for the moving object in the real space for two coordinate axes defining a plane on which the moving object moves.

7. The position estimating method according to claim 1, wherein the real space coordinate information indicating the predetermined point is information of real space coordinates for a plurality of points through which the moving object moves along a predetermined moving path.

8. The position estimating method according to claim 7, wherein the predetermined moving path is a path present in a region where a plurality of imaging apparatuses are configured to capture the moving object.

9. The position estimating method according to claim 8, wherein the information obtained from the correspondence further includes a parameter for adjusting a difference in a position of the moving object on images captured by the plurality of imaging apparatuses.

10. The position estimating method according to claim 1, wherein the real space coordinate information indicating the predetermined point is information of a plurality of real space coordinates based on position detection of the moving object by a position detecting apparatus.

11. The position estimating method according to claim 10, wherein the position detecting apparatus is a stereo camera included in the imaging apparatus.

12. A position estimating system comprising:
a control apparatus configured to control moving of a moving object;
an imaging apparatus configured to capture an image of the moving object; and
a position estimating apparatus configured to estimate position information for the moving object, wherein
the position estimating apparatus includes
a memory storing instructions; and
one or more processors configured to execute the instructions to:
obtain an image coordinate representing an image position of a moving object in an image captured by the imaging apparatus, and
convert the image coordinate for the moving object to a real space coordinate for the moving object, based on information obtained from a correspondence between real space coordinate information indicating a predetermined point in a real space and image coordinate information representing the predetermined point.

13. The position estimating system according to claim 12, wherein the control apparatus is configured to specify a path along which the moving object moves based on the real space coordinate for the moving object.

14. The position estimating system according to claim 13, wherein the control apparatus is configured to indicate to the moving object an instruction to move along the specified path.

15. The position estimating system according to claim 12, wherein the imaging apparatus is equipped with a stereo camera including a base camera and a reference camera.

16. The position estimating system according to claim 15, wherein the captured image is an image captured by the reference camera.

17. The position estimating system according to claim 15, wherein the imaging apparatus is configured to transmit a range image obtained by the stereo camera to the position estimating apparatus.

18. A position estimating apparatus comprising:
a memory storing instructions; and
one or more processors configured to execute the instructions to:
obtain an image coordinate representing an image position of a moving object in an image captured by an imaging apparatus; and
convert the image coordinate for the moving object to a real space coordinate for the moving object, based on information obtained from a correspondence between real space coordinate information indicating a predetermined point in a real space and image coordinate information representing the predetermined point.
